(19) United States
(12) Patent Application Publication
(10) Pub. No.: US 2014/0267748 A1
(43) Pub. Date: Sep. 18, 2014

(54) MULTI-CHANNEL NETWORK CAMERA SURVEILLANCE SYSTEM AND METHOD OF CONSTRUCTING THE SAME

(71) Applicant: Samsung Techwin Co., Ltd., Changwon-si (KR)

(72) Inventor: Young-Ki LEE, Changwon-si (KR)

(21) Appl. No.: 13/927,536

(22) Filed: Jun. 26, 2013

(30) Foreign Application Priority Data
Mar. 12, 2013 (KR) 10-2013-0026252

(51) Int. Cl. H04N 7/18; H04N 1/00

(52) U.S. Cl. CPC H04N 7/181; H04N 1/00244
USPC 348/159

(57) ABSTRACT

Provided are a multi-channel network camera surveillance system and a method of constructing the same. The multi-channel network camera surveillance system includes a master network camera including a photographing unit configured to capture an image and a storage unit configured to store first image data of the image captured by the photographing unit; a salve network camera which is connected to the master network camera and configured to capture an image and store second image data of the image captured by the slave network camera in the storage unit of the master network camera; and a client device which receives at least one of the first image data and the second image data from the master network camera.

This application claims priority from Korean Patent Application No. 10-2013-0026252 filed on Mar. 12, 2013 in the Korean Intellectual Property Office, the disclosure of which is incorporated herein by reference in its entirety.

### BACKGROUND

1. Field

Apparatuses and methods consistent with exemplary embodiments relate to a multi-channel network camera surveillance system, and more particularly, to a multi-channel network camera surveillance system including a plurality of slave network cameras which share a repository of a master network camera and a method of constructing the multi-channel network camera surveillance system as a large-scale network.

2. Description of the Related Art

A surveillance camera may be rotated in a horizontal or vertical direction to monitor an area in different directions, and an enlarged or reduced image of a subject may be captured by adjusting a zoom lens included in the surveillance camera.

The surveillance camera thus configured may be used for crime prevention and security purposes and attached to and installed in an area or place to be monitored. Images captured by the surveillance camera are output to a digital video recorder (DVR) and then displayed on the monitor screen or recorded on a recording medium such as a hard disk.

Of surveillance cameras, network cameras have no storage devices and thus transmit, in real time, captured image data to a storage device included in, e.g., a server. Therefore, an administrator has to access the server through a program in order to retrieve the image data captured by each network camera.

In a related art surveillance system in which a plurality of network cameras and a server are connected through a network as described above so as to transmit and receive image data, all network cameras should be connected online to continuously store image data. Therefore, if the network cameras are disconnected from the network, they cannot store the image data.

Further, if a problem occurs in the entire network, the image data of all network cameras are lost, making it impossible for the surveillance system to function properly.

In addition, the network cameras should be registered with the server which stores image data. To this end, the administrator has to manually allocate each of the network cameras to a channel of the server.

In particular, since the procedure of registering each of the network cameras to a channel of the server is complicated, the larger the number of network cameras, the more complicated it is to manage the network cameras.

### SUMMARY

One or more exemplary embodiments provide a multi-channel network camera surveillance system which can prevent a loss of image data even in a state where network cameras constituting the surveillance system cannot be connected to a network.

One or more exemplary embodiments also provide a multi-channel network camera surveillance system which can easily manage network cameras.

One or more exemplary embodiments also provide a method of constructing a multi-channel network camera surveillance system which can be easily expanded.

However, the inventive concept is not restricted to the exemplary embodiments set forth herein. The inventive concept will become more apparent to one of ordinary skill in the art to which the inventive concept pertains by referencing the detailed description given below.

According to an aspect of an exemplary embodiment, there is provided a multi-channel network camera surveillance system includes: a master network camera comprising a photographing unit configured to capture an image and a storage unit configured to store first image data of the image captured by the photographing unit; a salve network camera which is connected to the master network camera and configured to capture an image and store second image data of the image captured by the slave network camera in the storage unit of the master network camera; and a client device which receives at least one of the first image data and the second image data from the master network camera.

According to an aspect of another exemplary embodiment, there is provided a method of constructing a multi-channel network camera surveillance system which includes a plurality of network cameras connected to a network, the method includes: generating a plurality of units, each unit comprising at least one master network camera and a plurality of slave network cameras; setting at least one of the units as a master unit and setting the other units excluding the master unit as slave units; and connecting the slave units to the master unit such that the slave units are at a lower layer than the master unit.

### BRIEF DESCRIPTION OF THE DRAWINGS

The above and other aspects and features of the inventive concept will become more apparent by describing in detail exemplary embodiments thereof with reference to the attached drawings, in which:

FIG. 1 is a diagram illustrating a multi-channel network camera surveillance system according to an exemplary embodiment;

FIG. 2 is a diagram illustrating the connection relationship between network cameras shown in FIG. 1, according to an exemplary embodiment;

FIG. 3 is a block diagram illustrating the configuration of a master network camera shown in FIG. 1, according to an exemplary embodiment;

FIG. 4 is a diagram illustrating a multi-channel network camera surveillance system according to another exemplary embodiment;

FIG. 5 is a flowchart illustrating a method of constructing a multi-channel network camera surveillance system according to an exemplary embodiment;

FIGS. 6A and 6B are diagrams illustrating the connection relationship between network cameras of FIG. 5, according to an exemplary embodiment;

FIG. 7 is a flowchart illustrating a method of constructing a multi-channel network camera surveillance system according to another exemplary embodiment;

FIG. 8 is a diagram illustrating the connection relationship between network cameras of FIG. 7, according to an exemplary embodiment;

FIG. 9 is a diagram illustrating the connection relationship between the network cameras of FIGS. 7 and 8, according to an exemplary embodiment; and

FIG. 10 is a diagram illustrating a channel allocation and image transmission/reception process of a multi-channel network camera according to an exemplary embodiment.

### DETAILED DESCRIPTION OF THE EXEMPLARY EMBODIMENTS

The present inventive concept will now be described more fully hereinafter with reference to the accompanying drawings, in which exemplary embodiments are shown. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The same reference numbers indicate the same components throughout the specification. In the attached figures, the thickness of layers and regions is exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e. meaning “including, but not limited to.”) unless otherwise noted.

Spatially relative terms, such as “beneath,” “below,” “lower.” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

A multi-channel network camera surveillance system according to an exemplary embodiment will now be described with reference to FIGS. 1 through 3. FIG. 1 is a diagram illustrating a multi-channel network camera surveillance system according to an exemplary embodiment. FIG. 2 is a diagram illustrating the connection relationship between network cameras 100 shown in FIG. 1. FIG. 3 is a block diagram illustrating the configuration of a master network camera 100A shown in FIG. 1.

The multi-channel network camera surveillance system according to the current embodiment includes the master network camera 100A, a plurality of slave network cameras 100B and a client device 500. The master network camera 100A includes a photographing unit 110 which captures an image and a storage unit 150 which stores image data of the image captured by the photographing unit 110, which is referred to as “first image data” hereinafter. The slave network cameras 100B are connected to the master network camera 100A and store the captured image data in the storage unit 150 of the master network camera 100A, which is referred to as “second image data”. The client device 500 receives the first or second image data from the master network camera 100A.

Referring to FIG. 1, one or more network cameras 100 are connected to the client device 500 via a network 200.

Each of the network cameras 100 captures an image of the inside or outside of a building or a specific area and generates image data from the captured image. Each of the network cameras 100 may include a camera unit which actually captures an image, an encoder unit which is connected to the camera unit and generates analog or digital image data, and a transceiver unit which transmits the image data to a sensing monitor.

The network cameras 100 may be, for example, closed-circuit televisions (CCTVs). However, the network cameras 100 are not limited to the CCTVs. Each of the network cameras 100 can be any related art camera unit consisting of a plurality of optical lenses and a pickup device such as a charge coupled device (CCD).

As will be described later, some of the network cameras 100 may include a storage unit for storing captured image data, and the others may not include the storage unit.

In the example of FIG. 1, the network cameras 100 may be installed at different positions in order to monitor different areas A through D.

Each of the network cameras 100 may generate image data of an area at a predetermined angle from a position at which the network camera 100 is installed. Images of various subjects may be contained in the image data. The subjects may include various objects as well as people.

In addition, each of the network cameras 100 may include a driver such as an actuator. The driver enables each of the network cameras 100 to rotate along a predetermined axis of rotation to capture images at different angles.

Generally, the network cameras 100 are installed at certain positions for crime prevention and security purposes. Each of the network cameras 100 may be used to capture an image of an intruder who intrudes into a private land or a personal area or a suspicious person in order to prepare for possible intrusion in advance or obtain personal information of the intruder who escapes. However, the inventive concept is not limited thereto.

Image data obtained from each of the network cameras 100 may be transmitted to the client device 500 or a management application 400 separate from the client device 500 via the network 200.

In other embodiments, the management application 400 may be included in the client device 500.

Image data of the network cameras 100 may be retrieved through the management application 400 in order for surveillance purposes.

A storage server 300 may further be installed to store image data obtained from the network cameras 100 separately from the storage unit 150 included in at least one of the network cameras 100.

The storage server 300 may store image data obtained from all network cameras 100. If the storage server 300 is installed, a user can access the storage server 300 through the management application 400 and/or the client device 500 and retrieve image data stored in the storage server 300.

The storage server 300 may be installed for backup, logging or indexing purposes. Since at least one of the network cameras 100 includes the storage unit 150 having a storage medium, the storage server 300 may be omitted in other embodiments.

Referring to FIG. 2, the network cameras 100 may include the master network camera 100A which includes the storage unit 150 and the slave network cameras 100B which do not include a storage medium.

The storage unit 150 included in the master network camera 100A may be an external storage having a recording medium and connected to the master network camera 100A or may be included in the master network camera 100A.

The master network camera 100A and the slave network cameras 100B are identical in that they include the photographing unit 100 which captures an image. However, they are different in that the master network camera 100A further includes or is connected to the storage unit 150 which stores image data captured by the photographing unit 110. According to an exemplary embodiment, a master network camera may be used as a slave network camera of another master network camera. Thus, the master network camera 100A may be registered by a user to be distinguished from the other master network cameras functioning only as a slave network camera.

Each of the slave network cameras 100B is connected to the master network camera 100A and stores captured image data in the storage unit 150 of the registered master network camera 100A.

One master network camera 100A may be connected to a plurality of slave network cameras 100B. The master network camera 100A may receive captured image data from the slave network cameras 100B and store the received image data.

In response to a request from the client device 500, the master network camera 100A may load image data stored in the storage unit 150 and transmit the image data to the client device 500 via the network 200.

The client device 500 may receive the first or second image data from the master network camera 100A, specifically, from the storage unit 150 of the master network camera 100A.

The structure of the master network camera 100A will now be described with reference to FIG. 3.

The master network camera 100A may include a network image reception unit 120, a common interface unit 130, a buffer unit 140, a transmission unit 160, and a control unit 170, in addition to the photographing unit 110 which captures an image and the storage unit 150 which stores captured image data.

The network image reception unit 120 receives image data from each of the slave network cameras 100B and transmits the received image data to the common interface unit 130.

The storage unit 150 included in the master network camera 100A stores not only the first image data captured by the photographing unit 110 of the master network camera 100A but also the second image data received from each of the slave network cameras 100B. The first image data and the second image data may have different data forms and structures.

Therefore, the common interface unit 130 may be provided to convert the first image data and the second image data into the same data form and structure that can be stored in the storage unit 150.

The buffer unit 140 temporarily stores the first image data and the second image data which have been converted into the same data form by the common interface unit 130 before the first image data and the second image data are stored in the storage unit 150.

In particular, since the number of the second image data simultaneously received from the slave network cameras 100B is equal to the number of the slave network cameras 100B connected to the master network camera 100A, the amount of data that should be processed per unit time may significantly increase according to the number of the slave network cameras 100B.

This may impose a large overhead on the storage unit 150. To prevent this problem, the amount of data processed per unit time may be appropriately controlled using the buffer unit 140 before the first image data and the second image data are stored in the storage unit 150.

The transmission unit 160 retrieves image data stored in the storage unit 150 and transmits the retrieved image data to an external destination, for example, the client device 500.

The control unit 170 receives a request for image data from an external device, transmits a control command to the storage unit 150 and/or the transmission unit 160 in response to the request, and controls the storage unit 150 and/or the transmission unit 160 to transmit the requested image data to the external device.

In addition, the control unit 170 may control a plurality of channels connected to the slave network cameras 100B.

That is, the master network camera 100A includes a plurality of channels. The master network camera 100A may allocate the channels to the slave network cameras 100B and exchange data with the slave network cameras 100B through the channels, respectively.

Unlike a related art surveillance camera system, the multi-channel network camera surveillance system automatically allocates the channels and registers the slave network cameras 100B. Therefore, there is no need for an administrator to perform channel allocation. This will be described in more detail later with reference to FIG. 7.

As described above, the multi-channel network camera surveillance system according to the current embodiment connects the master network camera 100A and the slave network cameras 100B, which are physically separated from each other, via the network 200. Therefore, image data captured by the slave network cameras 100B which do not include a storage medium is transmitted to the master network camera 100A, and the transmitted image data is stored in the storage unit 150 of the master network camera 100A. That is, one storage unit 150 is shared by the slave network cameras 100B.

In addition, since the master network camera 100A automatically allocates the channels to the slave network cameras 100B, there is no need for an administrator to perform channel allocation.

A multi-channel network camera surveillance system according to another exemplary embodiment will now be described with reference to FIG. 4. FIG. 4 is a diagram illustrating a multi-channel network camera surveillance system according to another exemplary embodiment.

Referring to FIG. 4, the multi-channel network camera surveillance system according to the current embodiment includes a plurality of master network cameras 100A, each including a storage unit 150. Each of the master network cameras 100A is connected to a plurality of slave network cameras 100B.

In the example of FIG. 4, three slave network cameras 100B are allocated to each of three master network cameras 100A_1 through 100A_3. Therefore, among a total of twelve network cameras 100, three network cameras 100A include their own repository, whereas the other nine network cameras 100B do not include a storage medium.

A ratio of the master network cameras 100A to the slave network cameras 100B may be adjusted appropriately. That is, when it is required to manage image data in a centralized manner, the proportion of the slave network cameras 100B may be increased such that one master network camera 100A is connected to a large number of slave network cameras 100B. On the other hand, when it is required to manage image data in a distributed manner due to factors such as network instability, the proportion of the master network cameras 100A may be increased such that one master network camera 100A is connected to a small number of slave network cameras 100B.

In addition, the master network cameras 100A which can store image data irrespectively of the network state may be installed in important zones of the entire surveillance area in order to prevent a loss of image data.

Image data may be stored in the storage unit 150 of each of the master network cameras 100A and may be transmitted to the client device 500 via the network 200 in response to a request from the client device 500.

As described above, a storage server (not shown) may be installed separately from the storage unit 150 of each of the master network cameras 100A in order to perform a backup, logging or indexing operation during the storage and transmission of the image data.

A method of constructing a multi-channel network camera surveillance system according to an exemplary embodiment will now be described with reference to FIGS. 5, 6A and 6B. FIG. 5 is a flowchart illustrating a method of constructing a multi-channel network camera surveillance system according to an exemplary embodiment. FIGS. 6A and 6B are diagrams illustrating the connection relationship between network cameras of FIG. 5.

Referring to FIG. 5, in the method of constructing a multi-channel network camera surveillance system according to the current embodiment, to construct a multi-channel network camera surveillance system including a plurality of network cameras connected to a network, at least one of a plurality of network cameras is set as a master network camera (operation S510), and a plurality of slave network cameras connected to the master network camera are set (operation S520), and a plurality of slave network cameras at a lower layer which are connected to each of the slave network cameras are set (operation S530). Then, a plurality of slave network cameras at further lower layers are continuously set (operation S540, No) until all network cameras are connected (operation S540, Yes). When all network cameras are connected (operation S540, Yes), the construction of a multi-channel network camera surveillance system is completed.

In the setting of the at least one of the network cameras as the master network camera operation (operation S510), one of the network cameras may also be reset as the master network camera based on at least one of a preset order, a size of a network camera address, and a distance from the master network camera. That is, the master network camera is not fixed, and one of the slave network cameras may become the master network camera. In this case, the slave network cameras may be set hierarchically based on the new master network camera. The preset order is an order, set in advance by a system administrator, in which the network cameras are selected as the master network camera. The size of the network camera address refers to the size of a network address. The distance from the master network camera denotes that the network cameras are reset as the master network camera from a network camera located closest to the current master network camera.

In the setting of the slave network cameras at the lower layer which are connected to each of the slave network cameras (operation S530), each slave network camera at a higher layer to which the slave network cameras at the lower layer are connected is set as a master network camera and thus serves as both a master and a slave.

Therefore, after a user's search command for searching for image data is input first to the master network camera, it is transmitted to the other network cameras sequentially from the slave network camera at the hierarchically higher layer to the slave network cameras at the lower layer. Conversely, the search results or data of the network cameras are transmitted to the network cameras sequentially from the slave network cameras at the lower layer to the slave network camera at the higher layer, and then, finally to the master network camera. Therefore, layers at which slave network cameras are set may be appropriately determined by the number of slave network cameras and the performance of the slave network cameras.

Referring to FIG. 6A, in a multi-channel network camera surveillance system including a plurality of network cameras, at least one of the network cameras is set as a master network camera 100A_1. Then, a plurality of slave network cameras (100B_1; 100B_2, etc.) connected to the master network camera 100A_1 are set. Thereafter, a plurality of slave network cameras at further lower layers are continuously set until all network cameras are connected. Here, slave network cameras at the same layer may not necessarily be connected in equal numbers to each slave network camera at a higher layer. The slave network cameras at the same layer may also be connected in different numbers to each slave network camera at the higher layer.

Referring to FIG. 6B, the multi-channel network camera surveillance system may be constructed in a mesh shape as well as in a pyramid shape. For example, if the master network camera 100A_1 is changed, slave network cameras at the same layer (100B_1, . . . , 100B_1_ . . . _n, etc.) may be sequentially set, starting from network cameras located close to the new master network camera 100A_1.

The multi-channel network camera surveillance system can be expanded infinitely into a large-scale network by setting a mask network camera and slave network cameras as described above.

A method of constructing a multi-channel network camera surveillance system according to another exemplary embodiment will now be described with reference to FIGS. 7 through 9. FIG. 7 is a flowchart illustrating a method of constructing a multi-channel network camera surveillance system according to another exemplary embodiment. FIG. 8 is a diagram illustrating the connection relationship between network cameras of FIG. 7, according to an exemplary embodiment. FIG. 9 is a diagram illustrating the connection relationship between the network cameras of FIGS. 7 and 8, according to an exemplary embodiment.

Referring to FIG. 7, in the method of constructing a multi-channel network camera surveillance system according to the current embodiment, to construct a multi-channel network camera surveillance system including a plurality of network cameras connected to a network, a plurality of units, each including at least one master network camera and a plurality of slave network cameras, are generated (operation S710), at least one of the units is set as a master unit while the other units excluding the master unit are set as slave units (operation S720), and the slave units are connected to the master unit such that the slave units are at a lower layer than the master unit (operation S730). That is, one master network camera 100A and a plurality of slave network cameras 100B may form one unit. The network cameras may be controlled on a unit-by-unit basis. Alternatively, the network cameras may be controlled in such a manner that after a control signal is transmitted to the master network camera in a unit, it is transmitted simultaneously or sequentially to the slave network cameras in the unit.

Further, a plurality of groups, each including at least one master network camera and a plurality of slave network cameras, may be generated in each unit, and at least one of the groups may be set as a master unit, and the other groups excluding the master unit may be set as slave units and connected to the master unit such that they are at a lower layer than the master unit. That is, one master unit MU and a plurality of slave units SU_1 through SU_3 may form each group, and a hierarchical relationship, such as the master-slave relationship, may also be set between the groups.

For example, referring to FIG. 8, one master network camera 100A_1 and three slave network cameras 100B_1 may form one master unit MU, and slave units SU_1 through SU_3, each composed of a master network camera and slave network cameras, may be controlled by the master unit MU.

Therefore, when intending to search for a stored image, a user may transmit a search command to the master network camera 100A_1 of the master unit MU, and the master network camera 100A_1 of the master unit MU may transmit the search command to respective master network cameras 100A_2 through 100A_4 of the slave units SU_1 through SU_3.

As described above, a plurality of network cameras may not only be divided into a master network camera and slave network cameras but also may form a unit, and the units may also be hierarchically divided into a master unit MU and slave units SU_1 through SU_3.

In addition, referring to FIG. 9, a plurality of units, each including one master network camera and one or more slave network cameras, are divided into a master unit MU and a plurality of slave units SU_1 through SU_3, and the master unit MU and the slave units SU_1 through SU_3 may form each group.

The groups may be divided into a master group MG and a plurality of slave groups SG_1 through SG_3, and the slave groups SG_1 through SG_3 may form a layer lower than that of the master group MG.

Therefore, as described above, when intending to search for a stored image, a user may transmit a search command to a master network camera in the master unit MU of the master group MG, and the master network camera of the master unit MU of the master group MG may transmit the search command to respective master units MUs of the slave groups SG_1 through SG_3. Finally, the search command may be transmitted to the slave units SU_1 through SU_3 in each of the slave groups SG_1 through SG_3.

Data or signal transmission/reception within the master and slave units MU and SU may be performed as described above.

In the configurations of FIGS. 8 and 9, when desired data is found in a storage area of a network camera, the search result may be transmitted in an order reverse to the order in which a search command was transmitted. That is, the search result may be transmitted to network cameras, units, and then to groups. Finally, the master network camera of the master unit MU of the master group MG may transmit the search result to the client side.

The number of levels in this hierarchical relationship may be increased if necessary, and the number of cameras, units and groups at each level may be increased or decreased.

A channel allocation and image transmission/reception process of a multi-channel network camera according to an exemplary embodiment will now be described with reference to FIG. 10. FIG. 10 is a diagram illustrating a channel allocation and image transmission/reception process of a multi-channel network camera according to an exemplary embodiment.

Referring to FIG. 10, a master network camera 100A transmits a search packet to all slave network cameras 100B connected thereto through a network (operation S102). In this process, the search packet may not be transmitted to slave network cameras 100B connected to other master network cameras 100A.

Next, the slave network cameras 100B connected to the master network camera 100A receive the search packet and transmit a response to the search packet (operation S104). In this process, each of the slave network cameras 100B may determine whether to set up a relationship with the master network camera 100A based on information about the master network camera 100A which is included in the search packet.

For example, if the master network camera 100A which transmitted the search packet does not have an available channel or if the response speed of the master network camera 100A is equal to or less than a predetermined value, even a slave network camera 100B not allocated with a channel may not respond to the search packet.

Not responding to the search packet may include transmitting a negative connection response packet in response to the search packet.

Slave network cameras 100B which transmitted an affirmative connection response packet are allocated to channels of the master network camera which transmitted the search packet (operation S106). As described above, the master network camera 100A includes a plurality of communication channels which are independent from each other. The master network camera 100A is connected to one slave network camera 100B through one channel so as to exchange data with the slave network camera 100B.

Each of the slave network cameras 100B allocated with the channels transmits image data captured by a photographing unit to the master network camera 100A through a corresponding channel (operation S108).

The transmitted image data may be stored in a repository of the master network camera 100A (operation S110). In addition, image data captured by the master network camera 100A itself may be stored in the same repository.

A plurality of image data stored in the repository of the master network camera 100A can be retrieved using a management application 400. Specifically, when an administrator makes a request for image data using a menu item of the management application 400 (operation S112), the requested image is searched for (operation S114) and then transmitted to the management application 400 (operation S116).

As described above, since slave network cameras 100B are automatically allocated to channels of a master network camera 100A by transmission/reception of a search packet and a response packet, there is no need for an administrator to manually allocate the channels. Furthermore, when the number of network cameras in the entire system is increased or decreased or when the positions of the network cameras are changed, the channels can be automatically readjusted.

In concluding the detailed description, those skilled in the art will appreciate that many variations and modifications can be made to the above exemplary embodiments without substantially departing from the principles of the inventive concept. Therefore, the above exemplary embodiments are used in a generic and descriptive sense only and not for purposes of limitation.

1. A multi-channel network camera surveillance system comprising:
a master network camera comprising a photographing unit configured to capture an image and a storage unit configured to store first image data of the image captured by the photographing unit; a salve network camera which is connected to the master network camera and configured to capture an image and store second image data of the image captured by the slave network camera in the storage unit of the master network camera; and a client device which receives at least one of the first image data and the second image data from the master network camera.

2. The system of claim 1, wherein the slave network camera does not comprise a storage medium for storing the second image data.

3. The system of claim 1, wherein the slave network camera comprises a storage unit configured to store or not to store the second image data according to a user setting, and
wherein, if the slave network camera is set as a slave of the master network camera according to the user setting, the storage unit of the slave network camera is configured to transmit the second image data to the storage unit of the master network camera without storing the second image data in the storage unit of the slave network camera.

4-10. (canceled)

11. A method of constructing a multi-channel network camera surveillance system which comprises a plurality of network cameras connected to a network, the method comprising:
setting at least one of the network cameras as a master network camera; setting a plurality of slave network cameras connected to the master network camera; and
setting a plurality of slave network cameras at a lower layer which are connected to each of the slave network cameras.

12. The method of claim 11, wherein the master network camera comprises a photographing unit configured to capture an image and a storage unit configured to store image data of the image captured by the photographing unit of the master network camera, and
wherein the slave network camera comprises a photographing unit configured to capture an image and does not comprise a storage unit configured to store image data of the image captured by the photographing unit of the slave network camera.

13. The method of claim 11, wherein the slave network camera comprises a storage unit configured to store or not to store the second image data according to a user setting, and
wherein, if the slave network camera is set as a slave of the master network camera according to the user setting, the storage unit of the slave network camera is configured to transmit the second image data to the storage unit of the master network camera without storing the second image data in the storage unit of the slave network camera.

14. The method of claim 11, further comprising repeating the setting a plurality of slave network cameras at a lower layer.

15. The method of claim 11, wherein the setting at least one of the network cameras as a master network camera comprises resetting one of the network cameras as the master network camera based on at least one of a preset order, a size of a network camera address, and a distance from the master network camera to the other cameras in the multi-channel network.

16. The method of claim 11, wherein the setting a plurality of slave network cameras at a lower layer comprises setting each slave network camera at a higher layer, to which the slave network cameras at the lower layer are connected, as a master network camera.

17. A method of constructing a multi-channel network camera surveillance system which comprises a plurality of network cameras connected to a network, the method comprising:
generating a plurality of units, each unit comprising at least one master network camera and a plurality of slave network cameras;
setting at least one of the units as a master unit and setting the other units excluding the master unit as slave units; and
connecting the slave units to the master unit such that the slave units are at a lower layer than the master unit.

18. The method of claim 17, wherein the master network camera comprises a photographing unit configured to capture an image and a storage unit configured to store image data of the image captured by the photographing unit of the master network camera, and
wherein the slave network camera comprises a photographing unit configured to capture an image and does not comprise a storage unit configured to store image data of the image captured by the photographing unit of the slave network camera.

19. The method of claim 17, further comprising:
generating a plurality of groups, each group comprising at least one master network unit and a plurality of slave network units;
setting at least one of the groups as a master group and setting the other groups excluding the master group as slave groups; and
connecting the slave groups to the master group such that the slave groups are at a lower layer than the master group,
wherein each of the at least one master network unit comprises at least one master network camera and a plurality of slave network cameras, and each of the plurality of slave network units comprises at least one master network camera and a plurality of slave network cameras.
